(19) United States
(12) Patent Application Publication
(10) Pub. No.: US 2016/0092743 A1
(43) Pub. Date: Mar. 31, 2016

(54) APPARATUS AND METHOD FOR MEASURING A GAZE

(71) Applicant: HYUNDAI MOTOR COMPANY, Seoul (KR)

(72) Inventor: Jae Ho LEE, Uiwang-si (KR)

(21) Appl. No.: 14/562,219

(22) Filed: Dec. 5, 2014

(30) Foreign Application Priority Data
Sep. 30, 2014 (KR) 10-2014-0131615

(51) Int. Cl. G06K 9/03; G02B 27/01; G06K 9/00; G02B 27/00

(52) U.S. Cl. CPC G06K 9/03; G02B 27/0093; G02B 27/0101; G06K 9/00221; G06K 9/00597; G02B 2027/0138

(57) ABSTRACT

Method and apparatus implemented for measuring a gaze comprising recognizing the face of a user by using a camera provided in a vehicle; setting an initial k value by comparing the face of the user and face information of a database; and calculating a gaze point by using the k value. An interesting point by using a screen device of the vehicle is detected, the k value recalculated by comparing the gaze point and the interesting point; and the gaze of the user corrected according to the recalculated k value.

### CROSS-REFERENCE TO RELATED APPLICATION

This application is based on and claims priority from Korean Patent Application No. 10-2014-0131615, filed on Sep. 30, 2014 in the Korean Intellectual Property Office, the disclosure of which is incorporated herein in its entirety by reference.

### BACKGROUND

1. Field of the Technology

The present disclosure relates to an apparatus and method for measuring gaze, and more particularly, to technology capable of measuring gaze by interconnecting with an HUD/cluster when driving a vehicle.

2. Background Description

A gaze tracker utilizing gaze tracking technology can be roughly divided into two types, a remote method and a head mounted method, depending on purpose.

The remote method is one which is not fitted to a user and finds the gaze point of the user toward any given screen monitor or screen. This method does not cause discomfort when it is fitted to the user, but since use space is limited, this method cannot be used in a real environment. Furthermore, this method requires correction of the gaze point depending on movement of the user.

The head mounted method implements a device worn by the user and tracks the gaze of the user, finds the gaze point and maps it to the front image. According this method, it is possible to utilize gaze tracking in three-dimensional space of the real environment.

In order to estimate the gaze point, error depending on distance must be reduced. For use in the real environment, portability of the system and distance of the gaze point must be considered. Because the distance of the gaze point is different depending on the viewpoint of the front image and the viewpoint of the user, even though the user views the same direction, the results of mapping can be different depending on distance to the gaze point.

The gaze tracking method according to conventional gaze measuring must pre-define a fixed gaze point (eye gaze point) in order to measure the gaze point of the user, and also, the area for representing the gaze point is not large.

In addition, whenever the user is changed, the gaze point of the user must be measured again, which is an inconvenience.

### SUMMARY OF THE DISCLOSURE

a method for measuring a gaze capable of measuring the gaze point of a user when driving a vehicle, comprising correcting the gaze point by defining an interesting point (saliency point) using a screen signal or a device signal such as a HUD or cluster, and determining whether the interesting point is included in a certain area of the gaze point of the gaze tracker.

Other objects and advantages of the present invention can be understood by the following description, and they will become apparent by embodiments of the present invention. Also, it will be easily seen that the objects and advantages of the present invention can be realized by means described in the claims and combination thereof.

An apparatus for measuring a gaze according to an embodiment of the present invention comprises: a camera configured to recognize the face of a user in a vehicle; a gaze calculator configured to set a k value by comparing the face of the user and face information in a database, and calculate a gaze point by using the k value; an interesting point detector/comparator configured to detect an interesting point by using a screen device of the vehicle, and re-calculate the k value by comparing the gaze point and the interesting point; and a k value calculator/corrector configured to correct a gaze of the user according to the re-calculated k value.

The k value may be an angle difference between an optical axis of the camera and a visual axis of the user.

Also, if the interesting point is within an area including the gaze point, it may be determined that the user gazes at the interesting point, and if the interesting point is not within an area including the gaze point, it may be determined that the user does not gaze at the interesting point.

The screen device may include a HUD, a cluster, or a display device provided in the vehicle.

Also, the interesting point may be identified by using one signal of a speed warning signal of the vehicle, a warning signal of a lane departure warning system, a navigation guide signal, or a fuel warning signal.

A method for measuring a gaze according to an embodiment of the present invention comprises steps of: recognizing the face of a user by using a camera provided in a vehicle; setting an initial k value by comparing the face of the user and face information of a database; calculating a gaze point by using the k value; detecting an interesting point by using a screen device of the vehicle; re-calculating the k value by comparing the gaze point and the interesting point; and correcting a gaze of the user according to the re-calculated k value.

Also, the k value may be an angle difference of an optical axis of the camera and a visual axis of the user.

Also, if the interesting point is within an area including the gaze point, it may be determined that the user gazes at the interesting point, and if the interesting point is not within an area including the gaze point, it may be determined that the user does not gaze at the interesting point.

Also, the screen device may include a HUD, a cluster, or a display device provided in the vehicle.

Also, the interesting point may be identified by using one signal of a speed warning signal of the vehicle, a warning signal of a lane departure warning system, a navigation guide signal, or a fuel warning signal.

The present technology is the technology capable of automatically measuring the gaze of a user while driving a vehicle.

In addition, the present technology can define an interesting point by using the screen device such as a HUD or cluster of a vehicle.

In addition, the present technology can calculate k value by comparing the gaze point using a gaze tracker and the interesting point using the screen device of the vehicle, and correcting the personal gaze point.

In addition, the present technology is capable of accumulating data and utilizing it by using a database, after recognizing the face of a user or a driver.

### BRIEF DESCRIPTION OF THE DRAWINGS

The above and other objects, features and advantages of the present invention will be more apparent from the following detailed description taken in conjunction with the accompanying drawings, in which:

FIG. 1 is a configuration diagram explaining an apparatus for measuring gaze interworked with a HUD/cluster according to an embodiment of the present invention.

FIG. 2 is diagram explaining a method for determining a gaze situation by comparing the gaze point using a gaze tracker according to an embodiment of the present invention and the interesting point using the screen device of the vehicle.

### DETAILED DESCRIPTION OF THE PREFERRED EMBODIMENTS

The foregoing objects, features and advantages will be more apparent through the detail description as below with reference to the accompanying drawings, and thus the those skilled in the art can be easily embody the technical spirit of the present invention. Further, in the following description of the present invention, if it is determined that the detailed description for the known art related to the present invention unnecessarily obscures the gist of the present invention, the detailed description thereof will be omitted. Hereinafter, with reference to the accompanying drawings, preferred embodiments of the present invention will be described in detail.

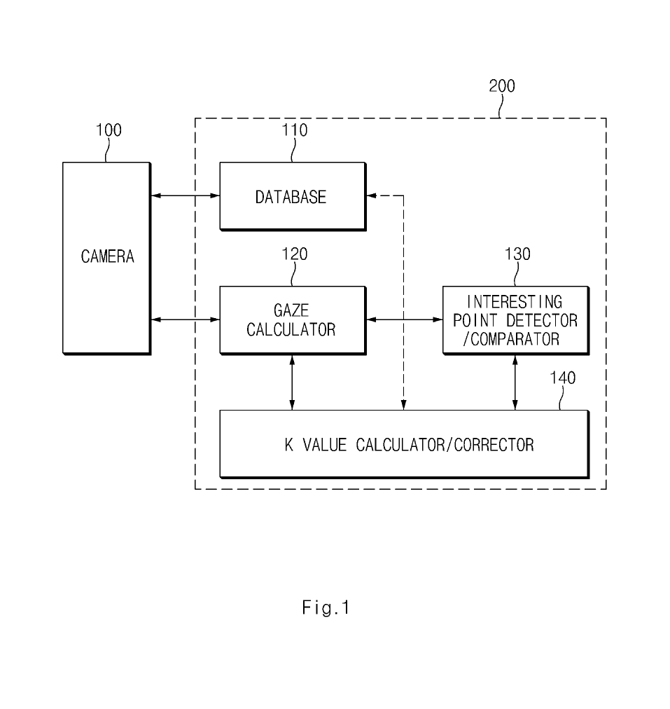

FIG. 1 is a diagram explaining the configuration of an apparatus for measuring gaze interfaced with a HUD/cluster according to an embodiment of the present invention.

Referring to FIG. 1, an apparatus for measuring gaze interfaced with a HUD/cluster includes a camera 100, a database 110, a gaze calculator 120, an interesting point detector/comparator 130 and a k value calculator/corrector 140. This apparatus for measuring gaze may include a plurality of illuminators, and the database 110, the gaze calculator 120, the interesting point detector/comparator 130 and the k value calculator/corrector 140 can be integrated and managed with one central processing unit (200, CPU).

The camera 100 recognizes the face of the user or the driver. Here, the camera 100 may include a plurality of wide angle cameras and narrow angle cameras. The wide angle camera receives image information, and can calculate the three-dimensional position for the user or driver. In addition, the narrow angle camera can perform pan, tilt and focus operations by using position information of the user or driver and eye area detection information.

The database 110 stores the information of the user or driver (particularly, face information).

The gaze calculator 120 calculates the gaze point. The gaze information including the gaze point is calculated from the center point information of the pupil and the reflection point information of the cornea. For example, if the user moves from the position performing the measurement between at least two wide angle cameras, the gaze calculator 120 corrects by applying the user position information to an omnidirectional movement correction model and then can calculate the gaze information by using the corrected user position information.

Specifically, the gaze point extracts the center point of the cornea from the reflection point of the cornea, and can extract the visible gaze by connecting the extracted central point of the cornea and the center point of the pupil.

The interesting detector/comparator 130 detects the interesting point, and compares the interesting point with the gaze point area including the gaze point. Here, the method for detecting the interesting point detects the interesting point by using the screen device such as the HUD or cluster of the vehicle. With generation signal generated by the screen device such as the HUD or cluster of the vehicle in real time, the reference coordinate (three-dimensional coordinate) of the interesting points can be identified, and it can determine whether the user or driver gazes at the interesting point or not when tracking a gaze. In particular, the interesting point is detected by receiving the signal using the screen device such as the HUD or the cluster, and the interesting point can be identified by using a signal associated with a speed warning, a lane departure warning system (LDWS) warning, a navigation guide, a fuel warning or a speed indicator.

The k value calculator/corrector 140 may calculate the k value by comparing the interesting point and the gaze point area including the gaze point, or perform an update, and any error of the gaze information by the user or driver's pupil shake of the user or driver can be corrected. Here, the k value means the angle difference of the optical axis of the camera and the visual axis of the user or driver.

The method for measuring a gaze interworked with a HUD/cluster will be described in detail as follows.

First, the face is recognized by using a camera. Here, the camera may include a plurality of wide angle cameras and narrow angle cameras. The wide angle camera receives image information, and can calculate the three-dimensional position for the user or driver through the measurement. In addition, the narrow angle camera can perform pan, tilt, and focus operations by using the position information of the user or driver and the eye area detection information.

Next, the database storing the face information of the user or driver and the face recognized by the camera are compared.

If the user or driver is not registered with the database, face information of the user or driver is newly registered, and the k value can be defined as 5 degrees which is estimated as the average value of a general person. Here, the k value means the angle difference between the optical axis of the camera and the visual axis of the user or driver.

However, if the user or driver is registered with the database, the k value stored depending on the user or driver can be set as an initial value.

Next, the gaze calculator of the gaze tracker performs gaze tracking on the user or driver. That is, the gaze point can be identified by performing the gaze tracking.

Next, the interesting point is defined by using a screen device such as the HUD or cluster of the vehicle. According to the generation signal generated in real time by the screen devices such as the HUD or cluster of the vehicle, the reference coordinate (three-dimensional coordinate) of the interesting point can be identified, and it can determine whether the user or driver gazes at the interesting point or not when tracking a gaze by the gaze tracker. That is, the k value is calculated by comparing the gaze point using the gaze tracker and the interesting point using the screen device of the vehicle, and the gaze can be corrected depending on the k value.

Specifically, the gaze point using the gaze tracker can set the gaze point area based on the current gaze point. Based on the current k value, the range can be set.

If the interesting point is within the gaze point area, it is determined that the user or driver currently gazes at the interesting point, and if the interesting point is not within the gaze point area, it is determined that the user or driver does not currently gaze at the interesting point.

Next, after it determines whether the user or driver gazes at the interesting point or not, the individual k value is corrected. That is, if user or driver gazes at the interesting point, k is updated as the current calculated k value, and if the user or driver does not gaze at the interesting point, the stored k value is used.

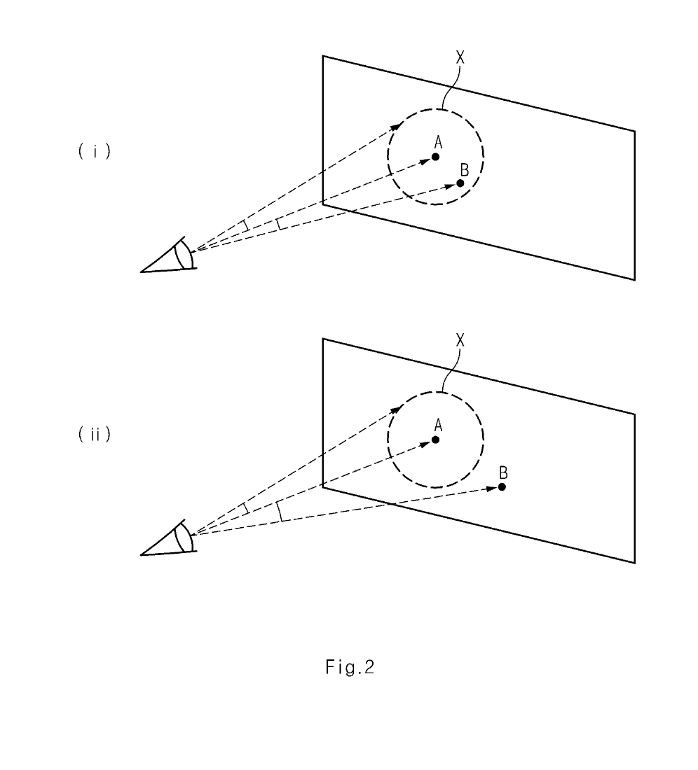

FIG. 2 is diagram explaining a method for determining a gaze situation by comparing the gaze point using a gaze tracker according to an embodiment of the present invention and the interesting point using the screen device of the vehicle.

Referring to (i) of FIG. 2, the gaze point (A) calculated by the gaze calculator and the currently generated interesting point (Saliency Point, B) are compared, and if the interesting point (B) is within the gaze point area (X), it is determined that the user or driver currently gazes at the interesting point (B).

Referring to (ii) of FIG. 2, the gaze point (A) calculated by the gaze calculator and the currently generated interesting point (Saliency Point, B) are compared, and if the interesting point (B) is not within the gaze point area (X), it is determined that the user or driver does not currently gaze at the interesting point (B).

As the above described, the present technology is capable of automatically measuring the gaze of a user while driving a vehicle.

In addition, the present technology can define the interesting point by using a screen device such as a HUD or cluster.

In addition, the present technology can calculate k values by comparing the gaze point using a gaze tracker and the interesting point using the screen device of the vehicle, and correct a personal gaze point.

In addition, the present technology is capable of accumulating data and utilizing it by a database, after recognizing the face of a user or a driver.

As the above described, although the present invention is explained by particular configurations and drawings, the technical concept of the invention is not limited to the aforementioned embodiments, and various modification and changes may be made within the equivalents of the technical concept of the present invention and the appended claims by those skilled in the art.

What is claimed is:

1. An apparatus for measuring a gaze comprising:
a camera configured to recognize the face of a user in a vehicle;
a gaze calculator configured to set a k value by comparing the face of the user and face information in a database, and calculate a gaze point by using the k value;
an interesting point detector/comparator configured to detect an interesting point by using a screen device of the vehicle, and re-calculate the k value by comparing the gaze point and the interesting point; and
a k value calculator/corrector configured to correct a gaze of the user according to the re-calculated k value.

2. An apparatus for measuring a gaze according to claim 1, wherein the k value is an angle difference of an optical axis of the camera and a visual axis of the user.

3. An apparatus for measuring a gaze according to claim 1, wherein, if the interesting point is within an area including the gaze point, it is determined that the user gazes the interesting point, and if the interesting point is not within an area including the gaze point, it is determined that the user does not gaze the interesting point.

4. An apparatus for measuring a gaze according to claim 1, wherein the screen device includes a HUD, a cluster, or a display device provided in the vehicle.

5. An apparatus for measuring a gaze according to claim 1, wherein the interesting point is identified by using one signal of a speed warning signal of the vehicle, a warning signal of a lane departure warning system, a navigation guide signal, or a fuel warning signal.

6. A method for measuring a gaze comprising steps of:
recognizing the face of a user by using a camera provided in a vehicle;
setting an initial k value by comparing the face of the user and face information in a database;
calculating a gaze point by using the k value;
detecting an interesting point by using a screen device of the vehicle;
re-calculating the k value by comparing the gaze point and the interesting point; and
correcting a gaze of the user according to the re-calculated k value.

7. A method for measuring a gaze according to claim 6, wherein the k value is an angle difference of an optical axis of the camera and a visual axis of the user.

8. A method for measuring a gaze according to claim 6, wherein, if the interesting point is within an area including the gaze point, determining that the user gazes at the interesting point, and if the interesting point is not within an area including the gaze point, determining that the user does not gaze the interesting point.

9. A method for measuring a gaze according to claim 6, wherein the screen device includes a HUD, a cluster, or a display device provided in the vehicle.

10. A method for measuring a gaze according to claim 6, wherein the interesting point is identified by using one signal of a speed warning signal of the vehicle, a warning signal of a lane departure warning system, a navigation guide signal, or a fuel warning signal.
